(19) United States
(12) Patent Application Publication
(10) Pub. No.: US 2024/0214732 A1
(43) Pub. Date: Jun. 27, 2024

(54) SOFT LISTENING DEVICE INCLUDING A PILLOW OR A STUFFED ANIMAL

(71) Applicant: Isabella Mowles, Powell, OH (US)

(72) Inventor: Isabella Mowles, Powell, OH (US)

(21) Appl. No.: 18/395,164

(22) Filed: Dec. 22, 2023

Related U.S. Application Data
(60) Provisional application No. 63/476,736, filed on Dec. 22, 2022.

(51) Int. Cl. H04R 5/02; A47G 9/10; A63H 3/28

(52) U.S. Cl. CPC H04R 5/023; A47G 9/1045; A63H 3/28; H04R 5/04; H04R 2420/07

(57) ABSTRACT

The disclosure provides a soft apparatus or listening device having one or more integrated speakers configured to play audio from a device external thereof. The soft apparatus or listening device can be a pillow or a stuffed animal. In one example, a soft apparatus is disclosed that includes: (1) one or more speakers located within the soft apparatus and (2) a communication interface configured to receive audio data from devices external to the soft apparatus.

### CROSS-REFERENCE TO RELATED APPLICATION

This application claims the benefit of U.S. Provisional Application Ser. No. 63/476,736, filed by Isabella Mowles on Dec. 22, 2022, entitled “SOFT LISTENING DEVICE INCLUDING A PILLOW OR A STUFFED ANIMAL,” commonly assigned with this application and incorporated herein by reference in its entirety.

### TECHNICAL FIELD

This application is directed, in general, to speakers, and more specifically to listening devices tailored for use by children.

### BACKGROUND

In the past, family road trips often involved children sitting shoulder to shoulder in a back seat of a car or way in the back of a station wagon looking out the back window. Sometimes different road games were played to pass time during the trip. In the modern era, children often engage in individual entertainment activities during travel, such as listening to music, playing games, or watching videos on their personal computing devices, such as computing pads, smartphones, or tablets. Since each child often wants to listen to their own entertainment, conflicts may arise due to competing audio in a confined space like a car, an airplane, train, or other type of vehicle. Individual listening devices, such as headphones or ear buds, can be beneficial since each individual is able to listen to their own audio with minimal interference to others.

### BRIEF DESCRIPTION OF THE DRAWINGS

Reference is now made to the following descriptions taken in conjunction with the accompanying drawings and illustrations in which:

FIG. 1 illustrates a block diagram of an example of a soft apparatus having one or more speakers and constructed according to the principles of the disclosure;

FIG. 2 illustrates a diagram of an example of a pillow having speakers according to the principles of the disclosure; and

FIG. 3 illustrates a diagram of an example of a stuffed animal having integrated speakers according to the principles of the disclosure.

### DETAILED DESCRIPTION

Unfortunately, for smaller children earbuds can be too large for their ears. As such, headphones that fit over the ears are often used in vehicles or in other enclosed areas, such as waiting rooms. Nevertheless, the pressure on the ears from wearing these types of headphones can cause discomfort. This is especially true when a child is trying to rest, such as by leaning his/her head up against a pillow on the window in a vehicle. Thus, a product that allows children to comfortably listen to their own audio without causing discomfort or disturbing others would be beneficial.

Accordingly, the disclosure provides a soft apparatus and listening device having one or more integrated speakers configured to play audio from a device external thereof. The soft apparatus can be, for example, a pillow or a stuffed animal. Thus, instead of laying on a pillow, such as in an automobile, with headphones on, the disclosure recognizes that a person, such as a child, would be more comfortable laying on a fluffy pillow or stuffed animal, and still be able to hear a desired audio from different types of computing devices, such as audio from a video running on an external computing device.

The external device can be a computing device, such as a mobile computing device, that sends the audio data via an audio signal, or simply audio, to the one or more speakers. As such, the soft apparatus further includes a communications interface that is configured to receive the audio from an external device and send the audio to the one or more speakers for playing.

The communications interface can receive the audio via a wireless or wired connection and can send the audio to the one or more speakers via a wireless or wired connection. Each of the wireless or wired connections can communicate using a standard protocol, such as a Bluetooth compliant or WLAN compliant protocol. The soft apparatus can include a pair of stereo speakers and the communications interface can send the left or right portion of the audio to the correct stereo speaker. The soft apparatus can include more than two speakers, such as a sufficient number of speakers for surround sound. In addition to a communications interface, the soft apparatus can also include a power supply that can be used to provide power for the one or more speakers.

The disclosed soft apparatus, whether a pillow or a stuffed animal, will allow a user to comfortably listen to their audio and limit interference to others, such as other people in a confined space. A confined space includes vehicles and enclosed rooms, such as waiting rooms, class rooms, hotel/motel rooms, and rooms of a home. The pillows or stuffed animals can be sized for different ages or age ranges of children and the location of the one or more speakers can be positioned within the pillows or stuffed animals according to the particular age or age range based on a typical positioning of the ears when a person of the particular age or age range rest their head on the pillow or stuffed animal. For example, stereo speakers can be separated 5 to 7 inches for children ages 10 to 12. For stuffed animals, a speaker or speakers can be positioned at the end of one or more limbs of the animal allowing a user to position the one or more speakers close to their ears for listening. A stuffed animal having four limbs can include up to four speakers with one located at the end of limbs, wherein a user can lay their head on the stuffed animal and wrap the limbs around their head or neck to position the speakers proximate their ears. The four speakers can provide surround sound.

The disclosure, therefore, provides a more comfortable way for users, such as children, to listen to their audio of choice while limiting audio interference to others proximate to the users. Accordingly, a collection of stuffed animals with built in speakers can be provided allowing users to snuggle up with the stuffed animals, get comfortable and listen to their audio during travel or when in other confined spaces with minimal effect on people located nearby, for example, within hearing. As such, children can sit in a back seat with their own computing pad watching their own video and listening to their own video via a soft apparatus having one or more integrated speakers as disclosed herein. The designs of the stuffed animals or pillows can have various shapes, and can be sized and directed to children of different ages or even senior adults who enjoy stuffed animals.

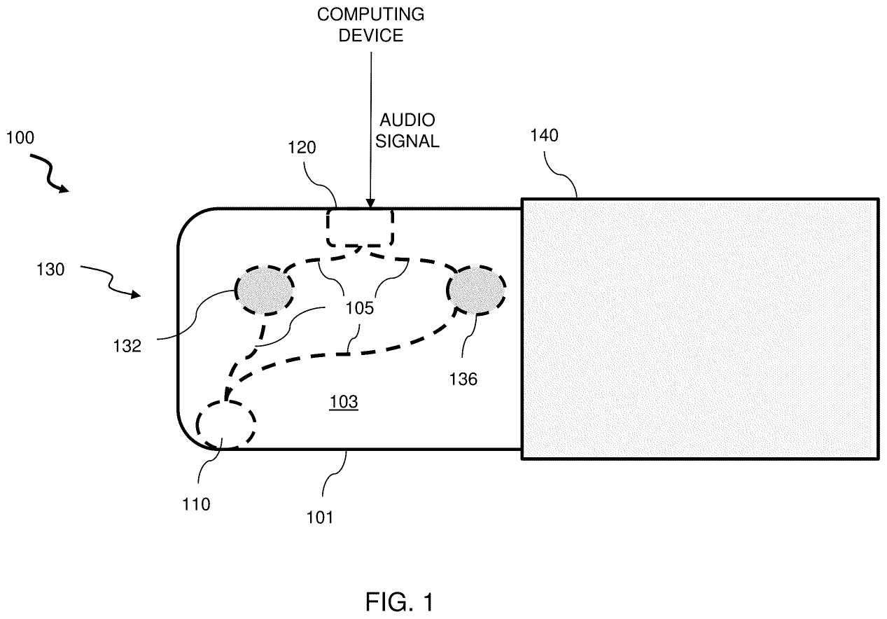

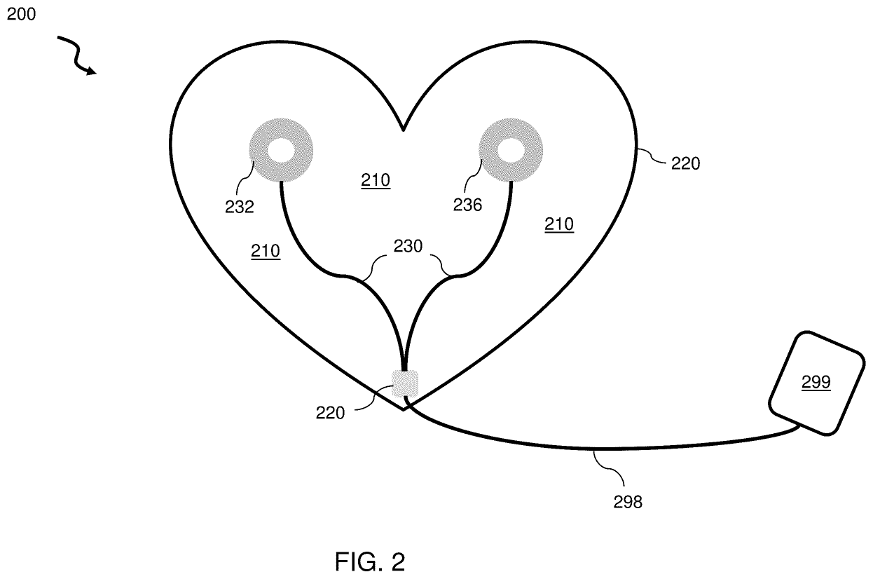

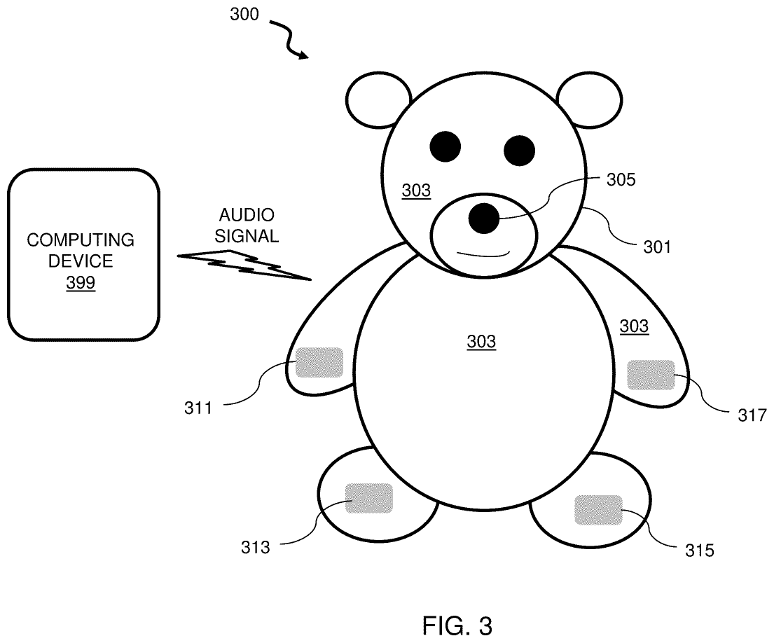

FIG. 1 illustrates a block diagram of a soft apparatus 100 having one or more integrated speakers and that is constructed according to the principles of the disclosure. The soft apparatus 100 includes a shell 101, filler material 103 located within the shell 101, a power supply 110, a communications interface 120, speakers 132 and 136, and a removable cover 140 that covers the shell 101. The shell 101 and the cover 140 are outer surfaces of the soft apparatus 100. The soft apparatus 100 provides a block diagram of a general example of a soft apparatus that includes integrated speakers and other components as disclosed herein. The soft apparatus 100 can be, for example a pillow. FIGS. 2 and 3 provide examples of a specialty pillow in the shape of a heart and a stuffed animal. The pillow and stuffed animal of FIGS. 2 and 3 can include components that function as those illustrated and discussed in FIG. 1

The power supply 110, communications interface 120, and speakers 130 can be connected via conventional means. In FIG. 1, wired connections 105 are shown for the connections. The power supply 110, communications interface 120, speakers 130, and connections are integrated within the shell 101. As noted below, the power supply 110 and the communications interface 120 can coincide with openings, such as slits, of the shell 101 to allow external charging and communicating, respectively, via wired connections. The openings can be opened or exposed when using and closed when not in use. A hook-and-loop fastener, zipper, buttons, or another type of fastener can be used to close the openings after charging batteries, replacing batteries, or communicating audio.

The shell 101 is constructed of a soft material, such as a soft fabric or cloth, and encloses the filler material 103 along with the integrated power supply 110, communications interface 120, and speakers 130. The filler material 103 or stuffing is also constructed of a soft material, such as down, feathers, or synthetic materials such as memory foam. The shell 101 and the filler material 103 can be constructed of material typically used with the shell and stuffing of pillows or stuffed animals.

The power supply 110, or energy module, can be one or more batteries. Non-rechargeable and chargeable batteries can be used. The power supply 110 can connect to a power source for charging if a rechargeable battery. The power source can be a typical wall outlet. Additionally, the rechargeable or non-rechargeable batteries can be removed and charged or removed and replaced. The power supply 110 can use a conventional connection for charging. The power supply 110 can also be a wireless chargeable battery that can be charged via a wireless power transmitter, such as an inductive charger. Charging via a wired connection or removing of the power supply 110 can be via an opening of the shell 101 as noted above. With wireless charging, such an opening is not needed.

The communications interface 120 can include the necessary circuitry and/or logic to receive audio from a device external to the soft apparatus 100 and provide the audio to the speakers 130. The circuitry and/or logic can be configured to send the audio to the proper speakers 132, 136, when stereo audio is available. With additional speakers, the communications interface 120 can also distribute the audio to the proper speakers, such as for surround sound. The communications interface 120 can be a conventional interface used for receiving and transmitting audio data via a wired connection, a wireless connection, or both. Various communication protocols can be used to receive the audio for either wired or wireless communications. Communicating via a wired connection can be via an opening of the shell 101 as noted above.

The speakers 132, 136, collectively referred to as speakers 130, are configured to play the audio received from the communications interface 120. The speakers 132, 136, can receive the audio via wired connections as shown in FIG. 1 or via wireless transmissions from the communications interface. For wireless speakers, the communications interface 120 may not be necessary. Instead, audio can be received directly from an external computing device.

Regardless if wired or wireless, the speakers 130 can be conventional speakers that are positioned within the shell 101 of the soft apparatus 100. The speakers 130 can be secured within the soft apparatus 100 at a desired position to optimize listening for users of certain ages, such as children. Thus, the soft apparatus 100 can come in different sizes and the distance between the speakers 132 and 136 can vary depending on a target age or age range. The speakers 132, 136, can be secured by being connected to the shell 101 at desired locations via various means. The speakers 132, 136, can also be securely positioned within the filler material 103. For example, the speakers 132, 136, can be located within a cavity of memory foam. The speakers 132, 136 can be stereo speakers.

The removeable cover 140 goes around the soft apparatus 100 and can be used to protect the shell 101 and filler material 103 from dirt, liquids, etc. Advantageously the removeable cover 140 can be removed, washed, and place back on the soft apparatus 100. The removable cover 140 can be non-permanently secured around the shell 101 using, for example, a hook-and-loop fastener, zipper, buttons, or another type of fastener. As with the shell 101 and the filler material 103, the removable cover 140 can be constructed of a soft material, such as cloth, fabric, silk, etc. In some examples, especially when wireless charging and communicating is available, a non-removable cover can be used or even no cover may be used. When the shell 101 has openings for the power supply 110 or the communications interface 120, the removable cover 140 can have corresponding openings to allow access to the power supply 110 and communications interface 120 without removing the cover 140.

FIG. 2 illustrates a diagram of an example of a pillow 200 having speakers 232, 236, integrated therein according to the principles of the disclosure. The pillow 200 is a heart-shaped pillow having filler material 210 that provides a comfortable listening device. The filler material 210 is contained within a shell 211. A cover, such as a removable cover as disclosed in FIG. 1, can encompass the shell 211 but is not denoted in FIG. 2. The shell 211 can also function as a cover and be a single outer surface. The shell 211 can be constructed of soft material such as the shell 101 and removable cover 140 of FIG. 1.

The speakers 232, 236, can be stereo speakers. The pillow 200 does not include a power source but does include a communications interface 220 that receives audio and provides the audio to the passive speakers 232, 236. The pillow 200 can include a power supply and powered speakers as shown in FIG. 1 in other examples. The communications interface 220 receives the audio via a cord 298 connected to a computing device 299 that is external of the pillow 200. The communications interface 220, the cord 298 and the computing device 299 can be conventional devices or components. For example, the computing device can be a computing pad (such as an Ipad from Apple), a smartphone, a computing tablet, or another computing device that provides audio designed to be listened to by a person. The audio provided via the cord 298 can correspond to a video playing on the computing device 299.

FIG. 3 illustrates a diagram of an example of a stuffed animal 300 having integrated speakers 310 according to the principles of the disclosure. The stuffed animal 300 is a bear and has a shell 301 that contains filler material 303 in the shape of the bear. As with the pillow 200, a cover can encompass the shell 301 but is not denoted in FIG. 3. The shell 301 can also function as a cover and be constructed of soft material such as the shell 101 and removable cover 140 of FIG. 1.

The speakers 310 are individually denoted as speakers 311, 313, 315, and 317, and are each located in a different limb of the stuffed animal 300. The speakers 310 connect directly to a computing device 399 to receive audio via a wireless signal. As such, the stuffed animal does not include a communications interface but the speakers 310 can wirelessly connect to the computing device 399 via conventional means to receive the audio. More than one stuffed animal or pillow having similar wireless integrated speakers can also wirelessly connect to the computing device 399 and simultaneously receive the audio. In such systems, audio can be wirelessly sent via a Wi-Fi transmitter. Additionally, the speakers 310 can be energized without being connected to a power supply via a wired-connection. For example, the speakers 310 can be wirelessly charged via an inductive charger. A charging indicator, such as a LED can be used to indicate available power. When a power supply is used, a charging indicator can also indicate the available power for the power supply. An example LED 305 is shown in FIG. 3 as an example. LEDs or other lights can also be included to provide status of other functions or provide other functions such as for operating or watching video on a computing device. One skilled in the art will understand that powered speakers connected to a power supply as shown in FIG. 1 can also be used. A communications interface and wired connections between the computing device 399 and the speakers 310 can be used.

The disclosed soft apparatuses and listening devices with integrated speakers provide an option for individuals, such as children, to listen to their chosen audio with minimum interference to others; especially in confined spaces. The soft apparatuses, especially the pillows, can have exchangeable covers and can be made for kids with fun designs or shapes that kids will want to buy. Stuffed animals and pillows with the integrated speakers can have different shapes and covers that can be collected. Kits for building the pillows or stuffed animals with integrated speakers can include fabric markers so kids can color and design their own unique pillow covers. The kits can also include accessories, or can be individually purchased, for the stuffed animals like capes and dresses so the kids can be excited to collect the accessories for the stuffed animal speakers.

The disclosed soft listening apparatuses or devices can have different covers, accessories, shapes, firmness levels and animal collections to entice collection of the devices. The devices can be Wi-Fi compatible for listening to audio as a child moves from room to room and can cooperate with home automated systems for listening, such as Alexis.

Those skilled in the art to which this application relates will appreciate that other and further additions, deletions, substitutions and modifications may be made to the described embodiments.

What is claimed is:

1. A soft apparatus, comprising:
one or more speakers located within the soft apparatus; and
a communication interface configured to receive audio data from devices external to the soft apparatus.

2. The soft apparatus as recited in claim 1, wherein the apparatus is a pillow or a stuffed animal.

3. The soft apparatus as recited in claim 1, wherein the communications interface is a wireless interface.

4. The soft apparatus as recited in claim 1, wherein the communications interface is a wired interface.

5. The soft apparatus as recited in claim 1, wherein the communications interface is a generic interface configured to communicate according to multiple protocols.

6. The soft apparatus as recited in claim 1, wherein the soft apparatus is a stuffed animal having at least two limbs and a speaker is located in each end of the limbs.

7. The soft apparatus as recited in claim 1, further comprising a power source configured to receive power for charging the one or more speakers.

8. The soft apparatus as recited in claim 1, wherein the power source wirelessly receives the power.

9. The soft apparatus as recited in claim 1, wherein the soft apparatus is a stuffed animal having four limbs that each have a speaker and the four limbs wrap around the head of a user when the user places their head on the stuffed animal.

10. A listening device, comprising:
a pillow or stuffed animal;
a communications interface integrated with the pillow or stuffed animal; and
at least one speaker within the pillow or stuffed animal.

11. The listening device as recited in claim 10, comprising at least two speakers.

12. The listening device as recited in claim 11, wherein the at least two speakers on stereo speakers.

13. The listening device as recited in claim 10, comprising four speakers.

14. A stuffed animal, comprising:
a soft outer surface; and
at least one speaker integrated therein.

15. The stuffed animal as recited in claim 14, further comprising a communications interface integrated therein.

16. The stuffed animal as recited in claim 14, wherein the outer surface is a covering.

17. The stuffed animal as recited in claim 16, wherein the covering is a removable and washable covering.
